(19) United States
(12) Patent Application Publication
(10) Pub. No.: US 2025/0141171 A1
(43) Pub. Date: May 1, 2025

(54) GUIDE DEVICE FOR ASSISTING IN MAKING AN ELECTRICAL CONNECTION

(71) Applicant: Murrelektronik GmbH, Oppenweiler (DE)

(72) Inventors: Olaf PREIN, Lügde-Rischenau (DE); Marco BOSCH, Weilheim a. d. Teck, (DE); Heiko FEISST, Schlierbach (DE); Christian KÜBLER, Backnang – Maubach (DE)

(73) Assignee: Murrelektronik GmbH, Oppenweiler (DE)

(21) Appl. No.: 18/923,793

(22) Filed: Oct. 23, 2024

(30) Foreign Application Priority Data
Oct. 27, 2023 (DE) 10 2023 129 767.8
Jun. 6, 2024 (DE) 10 2024 115 858.1

(51) Int. Cl. H01R 43/01; H01R 13/00; H01R 13/58; H01R 43/00

(52) U.S. Cl. CPC H01R 43/01; H01R 43/005; H01R 13/005; H01R 13/5845

(57) ABSTRACT

The invention relates to a guide device for assisting in making an electrical connection between a component and a cable, comprising:
a guide housing, and
a guide structure which is formed on the guide housing for guiding a contacting movement in order to contact at least one or multiple electrical contact means of the component with an associated electrical conductor of the cable in each case.

### RELATED APPLICATIONS

This application claims the benefit of priority of Germany Patent Application Nos. 10 2024 115 858.1 filed on Jun. 6, 2024 and 10 2023 129 767.8 filed on Oct. 27, 2023, the contents of which are incorporated by reference as if fully set forth herein in their entirety.

### FIELD AND BACKGROUND OF THE INVENTION

The present invention relates to a guide device according to the type defined in more detail in the preamble of claim 1. Furthermore, the invention relates to a connection system and a method.

### STATE OF THE ART

It is known from the state of the art that electrical cables are used pre-assembled during the installation of an electrical plant or are only assembled to a desired length in the field. However, the use of pre-assembled cables is inflexible and may be limited by the availability of the corresponding cables. Field assembly, on the other hand, is more flexible, but is often a time-consuming process.

To assemble the cable, the cable may first be stripped and crimped and then connected to a plug connector. A crimping tool, for example, is used to securely connect the plug connector to the conductors of the cable by applying pressure and deformation. A stripping tool may also be used to cut off the outer insulation of the lines without damaging the underlying conductors.

Furthermore, it is known from the state of the art that current Ethernet technology is often too complex and oversized for applications in the Industrial Internet of Things (IIoT). In particular, conventional plug connectors and cables are in many cases less optimal for use at field level. This makes the integration of sensors and other components more difficult, especially due to the cabling requirements and the limited cable length. A simplified Ethernet standard, Single Pair Ethernet (SPE), already offers a solution here through the combination of long cable lengths, compact design and robust cabling.

However, conventional solutions are still very costly when it comes to always providing the right cable length in the field.

It is therefore a task of the present invention to at least partially eliminate the disadvantages described above. In particular, it is the task of the present invention to further simplify the installation technology and to provide the right cable for an application in an improved manner. In particular, an improved, more flexible and/or simpler connection technology that may be used in the field is to be provided.

### SUMMARY OF THE INVENTION

The object of the invention is a guide device having the features of claim 1 and a connection system having the features of claim 15. Further features and details of the invention are apparent from the respective subclaims, the description and the drawings. Features and details which are described in connection with the guide device according to the invention naturally also apply in connection with the connection system according to the invention and the method according to the invention, and vice versa, so that reference is or may always be made reciprocally to the individual aspects of the invention with regard to the disclosure.

The object of the invention is, in particular, a guide device for assisting in making an electrical connection between a component and a cable. In particular, this may be understood to mean that a contacting movement, in particular linear, is guided in order to contact a respective conductor of the cable and the contact means of the component associated with this conductor. This may be achieved, for example, by a relative movement of the conductor and the contact means in relation to each other. The relative movement refers in particular to the relative movement of the conductor and the contact means with respect to each other, during which at least one of the two components is moved. This contacting movement may result in the respective contact means touching the associated conductor and therefore an electrical connection being established. The electrical connection may be further improved and/or fixed by moving and guiding the respective contact means further into the associated conductor. This further movement may also be part of the contacting movement and may be guided accordingly by the guide device.

The guide device may have a guide housing which is preferably at least partially electrically insulating. Furthermore, the guide device may have a guide structure which is formed on the guide housing for guiding a contacting movement in order to contact at least one or multiple electrical contact means of the component with an associated (i.e. assigned) electrical conductor of the cable in each case. For example, the guide structure may have at least one opening and/or at least one channel and/or the like, through which linear guidance of the respective conductor and contact means is made possible.

Furthermore, the guide device may be designed to specify the specific arrangement and assignment of the multiple electrical contact means to the multiple electrical conductors during contacting. In particular, this means that the “correct” contact means are connected to the “correct” associated conductors. For this purpose, the guide device may, for example, have a spatially formed coding. Coding may preferably be understood to mean a systematic shaping and/or arrangement of contacts and/or mechanical elements in order to ensure a specific connection configuration when making contact. The arrangement may refer to the orientation of the component with respect to the cable. The assignment may refer to an assignment of the respective contact means to an assigned (i.e. associated) one of the conductors, in particular according to a predetermined assignment of the conductors or contact means. The assignment of the contact means to the conductors implies in particular a mutual assignment, i.e. also an assignment of the conductors to the contact means.

Furthermore, an insertion mechanism may be provided, which is arranged on the guide structure for controlling the contacting movement in order to insert the at least one or the multiple electrical contact means into the associated electrical conductor in an axial direction of the conductor and/or the cable with a predetermined depth of penetration in each case. A mechanism may be provided here that enables assisted or automated insertion, in particular piercing, of the contact means into the conductor. This may have the advantage of facilitating the handling of the guide device and thus achieving greater precision in the connection of the cable to the component. The contacting movement may be controlled mechanically, but alternatively or additionally an electronic, e.g. sensor-supported, control may also be used.

Preferably, it may be provided that the insertion mechanism is designed to insert, in particular pierce, the respective contact means linearly guided by the contacting movement into the associated electrical conductor with the predetermined depth of penetration, in particular piercing depth, whereby preferably the predetermined depth of penetration is in the range of 0.5 mm to 10 mm, preferably 1 mm to 6 mm, preferably 2 mm to 4 mm. This may ensure that the insertion or piercing is carried out correctly.

For example, it may be provided that the insertion mechanism also has a pressure element and a transmission arrangement. The transmission arrangement may be connected to the pressure element in a force-transmitting manner in order to set the pressure element in motion when force is exerted manually or mechanically on the transmission arrangement. This enables the respective electrical contact means to be introduced, preferably pierced, into the associated electrical conductor by the pressure element via the contacting movement. Furthermore, a travel path for the pressure element between a starting position and an end position may be determined by the predetermined depth of penetration and/or may be structurally predetermined. By structurally predetermined is understood here in particular that the arrangement, shape and/or composition of the guide device is defined in such a way that the depth of penetration is achieved and/or the insertion is limited to the depth of penetration.

Furthermore, it is optionally provided that an adjusting mechanism is provided to adjust the predetermined depth of penetration and preferably the travel at the insertion mechanism, preferably depending on a cable type of the cable and/or steplessly and/or in several predefined steps. This may have the advantage that the insertion mechanism may be adapted to different cable types to ensure optimum depth of penetration and travel. This enables reliable and efficient cable installation. It is also possible for the adjusting mechanism to be operated automatically or manually and provide an indexing device to monitor the settings. This allows the operator of the insertion mechanism to quickly and easily adjust the settings to ensure precise and reliable cable installation.

Preferably, it may be provided that the insertion mechanism is designed as a lever mechanism, in which a transmission arrangement comprises a lever arm in order to transmit a manual or mechanical force exerted on the transmission arrangement into the controlled contacting movement, in which the control is preferably such that the contacting movement is guided linearly and/or the depth of penetration is predetermined and/or controlled and/or limited and/or the predetermined and/or a current depth of penetration is indexed for a user, for example by a display device.

It is also advantageous if an indexing device, preferably a display device, is provided in order to visually or haptically or acoustically indicate, in particular display, a current depth of penetration during the contacting movement, the indexing device preferably being designed as one of the following for this purpose:
a visual scale for displaying the current depth of penetration, preferably by means of markings for different positions along a travel of a pressure element of the insertion mechanism, e.g. by printing the scale on the guide housing,
a latching mechanism in which latching means are provided at the various positions in order to give an operator of the guide device haptic feedback when the pressure element reaches the various positions,
a click or snap mechanism to provide acoustic feedback when the pressure element reaches the various positions,
a device with mechanical resistance elements at the various positions,
a device with magnetic position markers at the various positions.

Furthermore, it is conceivable that the insertion mechanism also has a nut, preferably a union nut, which is designed to establish a mechanical connection between the component and the cable and to be screwed onto a thread for this purpose. A transmission arrangement may also be provided, which is designed to transmit a movement, in particular a rotary movement, of the nut on the thread to a pressure element. A pressure element may be arranged and guided in the area of a guiding space of the guide device in order to move through the guiding space of the guide structure by the transmitted movement along a longitudinal axis of the thread in order to exert a force for inserting the electrical contact means. The guiding space may be designed to accommodate a part of the component and/or the at least one electrical contact means. The guiding space may be adapted to the dimensions of the cable for this purpose.

Optionally, the insertion mechanism may further comprise a pressure element to directly or indirectly transmit a force to the electrical contact means to insert it into the associated electrical conductor via the contacting movement. Furthermore, a holding element may be provided, which is firmly connected to the pressure element in order to limit the contacting movement when the holding element encounters a counter-holding element. Preferably, the counter-holding element, and in particular other counter-holding elements at regular intervals, may be arranged along an axial direction of the cables to visually and mechanically mark the predetermined depth of penetration. This may have the advantage that the depth of penetration may be quickly and easily checked visually without the need for special measuring devices. Furthermore, the arrangement of the counter-holding elements at regular intervals may also help to ensure that the cable is held in the predetermined position in a uniform and stable manner. This in turn may help to ensure that the cable does not slip or become damaged during operation.

A further advantage may be that the guide device is designed to predetermine the specific arrangement and assignment of the multiple electrical contact means to the electrical conductors during contacting, whereby the guide structure is designed to guide the contacting movement in the form of a linear relative movement of the electrical contact means and the electrical conductors to each other during contacting. For this purpose, the guide structure may, for example, have a spatial boundary for the conductors and the contact means, in which either the conductors and/or contact means are guided individually or together. The linear guide may be achieved by arranging a respective conductor with the associated contact means (and/or a respective contact means with the associated conductor) in a straight line and holding and guiding it on this line by the spatial boundary. The conductors are assigned to the contact means, for example, on the basis of a predefined electrical assignment. In this context, especially in connection with plug connectors, an electrical assignment may be understood to mean that each contact means fulfills a specific electrical function and is thus assigned to a specific conductor. The guide device may help to ensure that the conductors are not connected incorrectly and that the component, in particular a plug connector, functions properly.

Furthermore, within the scope of the invention, it may be provided that the guide structure is formed on a first side of the guide housing for mechanically guiding the electrical conductors. For this purpose, the guide structure may, for example, comprise openings on the first side of the guide housing. The guide structure may be formed on a second side of the guide housing for mechanical guidance of the electrical contact means. For this purpose, further openings may be provided on the second side of the guide housing in order to guide the electrical conductors and the electrical contact means from the different sides towards each other, so that the contacting is preferably provided guided in an interior space of the guide housing. This may have the advantage that the contacting movement may be carried out easily and safely inside the guide housing. For this purpose, the interior may be designed with dimensions and a shape that are adapted to the shape and size and preferably the diameter of the cable.

Preferably, within the scope of the invention, it may be provided that at least one coding is spatially formed on the guide housing in order to predetermine the specific arrangement and assignment of the electrical contact means to the electrical conductors. The at least one coding may comprise a mechanical and/or geometric coding in which a geometric profile, in particular a spatial shape and/or contour, extends through the guide device. Preferably, the profile may define a guide cavity for a guide means and preferably for a guide pin of the component and/or cable. This has the effect of predetermining a specific orientation of the component and/or cable for contacting. Furthermore, it makes it possible to block a movement of the component and/or the cable relative to one another in the event of a deviation from the specific orientation. In particular, the contacting movement may thus be prevented.

The at least one coding may be spatially formed by comprising a geometric and/or extruded profile of the guide device and/or a tube. Particularly preferably, the guide cavity may be designed to transfer a fluid, in particular to transfer a medium such as air or a liquid. For example, the profile may be formed on the cable in an extrusion process.

It is also conceivable that at least one coding is provided on the guide housing, whereby the at least one coding comprises an electrical coding and/or a color coding, in which a systematic arrangement of the electrical conductors is provided. This has the advantage that a specific assignment of the electrical contact means is predetermined for the contacting. The assignment may relate to a specific connection arrangement in which the electrical contact means are contacted in a defined order.

The guide device may comprise an insertion mechanism, in particular a screw mechanism, a lever mechanism or a plug-in mechanism, to perform the contacting movement, the insertion mechanism preferably being designed to move the cable towards the component during the contacting movement, the guide device or the insertion mechanism preferably comprising an adjusting mechanism, to set a predetermined depth of penetration of the contact means into the conductor at the insertion mechanism, preferably depending on a cable type of the cable and/or continuously and/or in several predefined steps, wherein the guide device or the insertion mechanism preferably comprises an indexing or indexing device which is adapted to index the current depth of penetration for a user during the contacting movement. The insertion mechanism may be a previously mentioned insertion mechanism.

Preferably, the screw mechanism is designed as a union nut or comprises a union nut that establishes the electrical connection when screwed to the component. A lever of the lever mechanism may preferably be mounted on the component. Actuation of the lever may cause the contacting movement. Preferably, the component comprises a thread, for example an M8 or M12 thread, preferably as an external thread, and the union nut comprises a mating thread, preferably an internal thread.

The insertion mechanism may include a gripper, for example. The insertion mechanism or gripper may be part of the component, attached to the component or separate to the component. The gripper may grip the cable or a cable end section, preferably by the cable or cable end section being clamped or held by the gripper. Preferably, the gripper interacts with the strain relief contour and/or the coding of the cable for this purpose, preferably by the gripper gripping behind the raised portion or engaging in the recess. Preferably, the gripper has the counter-coding. In other words, the cable may only be gripped in the intended orientation by means of the gripper in order to establish an intended electrical connection between the cable and the component, in particular between the electrical conductors of the cable and the contact means of the component.

Preferably, the insertion mechanism may be used not only to establish the electrical connection, but also to establish the necessary surface pressure for a sealing element, in particular an elastomer seal, on the component. The seal may be arranged in such a way that it is in physical contact with the contact surface when the electrical connection is made. The seal may have been produced by means of a multi-component injection molding process during the manufacture of the component. The seal may seal the transition and/or the fluid conduit and/or the fluid channel from the contact points, between the electrical conductors and the contact means, and/or seal the contact surface from an environment of the connection system. By means of the insertion mechanism, the cable, which is held and/or retainable by the gripper, may be moved towards the component, preferably to establish the electrical connection between the cable and the component, in particular between the electrical conductors of the cable and the contact means. The insertion mechanism is designed such that the contact means may only be contacted by piercing the electrical conductors of the cable at the contact surface.

The indexing may be designed as a scale or as acoustic and/or haptic feedback for the user. For example, latching noises of a latching mechanism due to the contacting movement may trigger such acoustic feedback. It is also conceivable that engagements of a or the engagement mechanism during the contacting movement generate the haptic feedback. The scale may be formed on the component for this purpose, while preferably the insertion mechanism, in particular the screw mechanism, lever mechanism or plug-in mechanism, may act as a pointer to the scale.

The adjusting mechanism may be designed as an adjustable movement limiter for the insertion mechanism, in particular a screw mechanism, lever mechanism or plug-in mechanism, which preferably limits the maximum depth of penetration or the maximum depth of insertion of the contact means into the conductor. The adjusting mechanism may, for example, be adjustable by means of a screw or a union nut and/or rotary movement. Preferably, the insertion mechanism has a movement converter which may be designed in such a way that an actuating movement, in particular pushing movement or rotary movement or pivoting movement, is converted or may be converted into a contacting movement.

Within the scope of the invention, it may be provided that the guide device is designed as a guide grommet for the cable. The guide grommet is characterized in particular by the fact that it fixes the cable in a defined alignment and/or protects it from damage. For this purpose, the guide grommet may be made of a flexible material such as rubber or plastic and have an internal guide groove that holds the cable securely and stably.

Another object of the invention is a connection system comprising:
a component for connection to an electrical cable, the component comprising at least one or multiple contact means for making contact in each case with an associated conductor of the cable, the respective contact means being electrically conductive,
the electrical cable, in which the respective associated conductor is accessible for contacting, wherein the respective conductor is electrically conductive, and wherein the respective conductor has an exposed conductor cross-section,
a guide device, in particular according to the invention, for supporting the contacting of the respective contact means with the associated conductor, wherein the guide device has a guide housing which is designed to be at least partially electrically insulating, and wherein the guide device has a guide structure which is designed on the guide housing for guiding a contacting movement of the respective conductor and/or the respective contact means for contacting.

The guide device may also have:
an insertion mechanism which is arranged on the guide structure for controlling the contacting movement in order to insert the respective contact means with a predetermined depth of penetration into the associated electrical conductor in an axial direction of the conductor and/or the cable.

The connection system according to the invention thus has the same advantages as those described in detail with reference to a guide device according to the invention.

It is also possible that the connection system for contacting the respective contact means with the associated conductor is designed in an axial direction of the associated conductor in order to electrically connect the respective contact means directly to the exposed conductor cross-section of the associated conductor. For this purpose, the contact means may, for example, be pierced into the conductor cross-section in the longitudinal direction of the conductor. Alternatively or additionally, the at least one coding may be formed by means of a cross-section of the cable that is free of rotational symmetry, in particular by means of an inner and/or outer contour of the cable that is free of rotational symmetry. The respective exposed conductor cross-section may be completely exposed in cross-section, e.g. cut through. The rotationally symmetry-free outer contour may be formed by means of a cable sheath or outer circumference of the cable, preferably in that the cable has a cross-section with a circular basic shape and at least one recess, in particular a groove, and/or at least one elevation, in particular a bead. Preferably, the recess or elevation, in particular the bead, is the coding. Alternatively, the outer contour may be a free form or a polygonal shape. The inner contour may be formed by means of a circular fluid line, which forms the coding due to its position and/or shape within the cross-section of the cable. Alternatively, the fluid line may have a free form or the shape of a polygon. Due to the coding, the component with the coding may be regarded as a key and the component with the matching counter-coding as a lock. This may ensure the intended specific contact between the conductors and the contact means.

According to a further advantage, it may be provided that the respective contact means has a tip and/or is needle-shaped in order to contact the associated conductor by piercing the contact means at and/or through the, in particular completely, exposed conductor cross-section. In particular, the piercing comprises a contacting movement in which a force may be applied to the contact means in order to create an opening or passage in the conductor cross-section.

It is also possible that the respective conductor is designed as a strand, which has flexible single wires in order to electrically conductively surround a contact means inserted and in particular pierced through the respective conductor cross-section. This has the advantage that a flexible receptacle for the contact means is provided by the single wires, thus simplifying insertion.

According to a further possibility, it may be provided that the respective contact means is designed to be inserted, preferably pierced, into the conductor at and/or through the exposed conductor cross-section of the associated conductor, wherein the respective conductor with its exposed conductor cross-section and the contact means inserted, preferably pierced, therein are at least partially surrounded by an insulating sheath and/or shielding. This may have the advantage that the respective conductor, in particular data conductors for sensitive data transmission, is protected from external influences such as electromagnetic interference or mechanical damage. In addition, the insulating sheath and/or shielding may also help to protect the conductors from moisture and corrosion, which may increase the service life and reliability of the cable.

The electrical conductors of the cable may be twisted together, in particular in the form of one or more twisted pairs, twisted threes or twisted fours, the at least one coding having a continuous course along the length of the cable and a course which is matched to the twisting such that at any point of the cable along the length of the cable the at least one coding and the electrical conductors have the same relative position to one another, in particular in a plane transverse, preferably perpendicular, to the direction in which the cable extends. In other words, the coding on the cable sheath may have a continuous helical course in the direction in which the cable extends, preferably with a constant pitch, which is matched in particular to the twisting. The coding may be in the form of a recess, in particular a notch or groove, or an elevation, in particular a shoulder or bead. The twisting may reduce electromagnetic interference. By twisting the conductors, induced electromagnetic fields largely cancel each other out, reducing susceptibility to interference. However, this changes the position of the conductors along the length of the cable, making contact between the contact means of the component and the conductors of the cable more difficult. By means of the coding and the defined, constant relative position of the coding to the conductors along the cable, this problem may be solved and the intended contacting between the contact means of the component and the corresponding conductors of the cable may be made possible at any point of the cable, as the coding may have a continuous course that is matched to the twisting. The various strandings may be spaced apart and/or evenly distributed in the cross-section of the cable. If the cable has a fluid line, it is preferred if the strandings are arranged evenly around the fluid line, preferably in order to achieve uniform cooling of the conductors or the strandings.

The cable may have a fluid line, in particular a liquid line or gas line, wherein in particular the at least one coding may be formed partially or only by means of the fluid line, wherein the electrical conductors, in particular the stranding or strandings, surround the fluid line along the extension of the cable in order preferably to ensure uniform cooling of the conductors by means of the fluid which may be conducted through the fluid line, wherein the component may have a fluid channel which may be connected in a fluid-transmitting manner to the fluid line of the cable and may in particular form a counter-coding partially or only. Preferably, the fluid line and/or the fluid channel contributes to the coding by the shape of its cross-section, in particular transverse or perpendicular to the direction in which the cable extends, and/or by its position within the cable cross-section, in particular transverse or perpendicular to the direction in which the cable extends. Contributing to the coding may mean, for example, that a geometry of the cable sheath or the outer contour of the cable also contributes to the coding. In other words, a geometry of the cable sheath or the outer contour of the cable together with the fluid line, in particular the shape and/or position of the fluid line, may form the coding. Alternatively, preferably only the fluid line forms the coding by the shape of its cross-section, in particular transverse or perpendicular to the direction in which the cable extends, and/or by its position within the cable cross-section, in particular transverse or perpendicular to the direction in which the cable extends.

The cable may have along its extension on its outer circumference, preferably at regular intervals from one another, strain relief contours, particularly preferably in the form of circumferential recesses, in particular grooves or notches, or elevations, in particular beads or steps, preferably for a heat-shrink tubing or a strain relief, and wherein the component may have a strain relief, in particular a heat-shrink tubing designed as strain relief, which is preferably attached to the component, for the cable, which cooperates with the strain relief contour of the cable in such a way that the cable is strain-relieved, in particular by the strain relief forming a form-fit with the strain relief contour of the cable, preferably by the strain relief engaging behind the strain relief contour or engaging in the strain relief contour. Preferably, the strain relief is designed in such a way that the strain relief pretensions the cable against the component, preferably in the direction of extension of the cable and/or in the direction of contacting. Furthermore, the strain relief may comprise gripper arms for engaging or gripping behind. The strain relief may be made of plastic and/or in one piece with the component. The strain relief may also be adjustable, so that the pretension of the cable against the component may be adjusted. The pretension may be adjustable in steps or continuously. Preferably, the strain relief may be designed in such a way that it establishes a strain-relieving connection with the strain relief contour during the contacting movement to establish the electrical connection between the cable and the component.

An electrical connection may preferably be established between the cable and the component, in particular by the contact means being pierced into associated conductors, the connection system comprising a seal, in particular a material-fitting and/or force-fitting and/or form-fitting seal, which seals the connection and in particular a cable section adjacent to the connection from an environment of the connection system, in particular in accordance with IP20 or IP67, wherein the seal may preferably, in particular in the case of a form-fit seal, be formed by means of a heat-shrink tubing or the heat-shrink tubing which forms the strain relief. IP20 may be a protection and/or certification that states that the ingress of foreign bodies is prevented. IP67 may be a protection and/or certification that states that there is protection against dust and submersion in water up to a maximum depth of 1 meter for a maximum of 30 minutes. Preferably, IP20 and IP67 refer to the protection classes and/or certifications as they were valid on 27.09.2024, in particular in the Federal Republic of Germany.

The seal may preferably be formed by means of a sealing compound, in particular adhesive or casting compound, whereby, in particular in the direction of extension of the cable and/or perpendicular to the direction of extension of the cable, a sealing chamber may be formed between the cable, in particular the contact surface of the cable, and the component for receiving the sealing compound, in which the sealing compound is located and preferably completely fills the sealing chamber, wherein the sealed chamber preferably has a filler opening for the sealing compound, which is in particular closed by the sealing compound, wherein the sealed chamber preferably has an outlet opening for the sealing compound, which is in particular closed by the sealing compound, wherein in particular a section of the component delimiting the sealed chamber may be formed from a transparent material so that the degree to which the sealed chamber is filled with the sealing compound may be determined optically. The sealing compound may be filled into the sealed chamber in a liquid state by means of the filler opening. By means of the outlet opening, excess sealing compound filled in may escape from the sealed chamber in a liquid state, making it possible to determine whether the sealing compound has been evenly distributed in the sealed chamber. The sealing compound is preferably curable and/or electrically insulating. Closing the openings with the sealing compound may prevent foreign bodies or moisture from entering the sealed chamber.

The seal may be formed by means of a released content of a microencapsulation, in particular of the cable or the component or the guide housing. The contents of the microencapsulation may preferably have been released by means of heat supply, radiation, in particular light supply, preferably in the form of ultraviolet light, contact with an activation substance or light supply in combination with moisture.

The seal may seal and/or electrically insulate a transition from the fluid line to the fluid channel from the contact points, which may be formed by means of contacting the conductors with the contact means on the contact surface, in a fluid-tight manner, and/or whereby the seal electrically insulates and/or seals the contact points, which may be formed by means of contacting the conductors with the contact means on the contact surface, from one another. In this way, leakage of the fluid or a malfunction is prevented.

The seal may be formed by means of a heat-shrink tubing, whereby the heat-shrink tubing is preferably designed as a strain relief for the cable, in that the heat-shrink tubing forms a form-fit in particular with a strain relief contour of the cable, preferably in that the heat-shrink tubing engages behind the strain relief contour or engages in the strain relief contour, and is attached to the component by means of an attachment of the component, in particular an attachment contour of the component, and thus preferably forms a pretension of the cable against the component. Alternatively, it is conceivable that the heat-shrink tubing merely serves as a seal.

The contact means may electrically lead to electrical contact conductors of a plug assembly or socket assembly of the component, whereby the position and/or arrangement and/or assignment and/or dimensioning of the electrical contact conductors differs from that of the contact means, in particular on the contact surface. The course of the guide from the contact means to the contact conductors of the plug or socket may preferably not be straight, but at least at one point of the course be angled, preferably vertically, or curved, whereby the plug or socket is formed on a side of the component that runs transverse or perpendicular to the insertion direction of the cable or to the contacting direction. The plug may be designed to establish an electrical and/or form-fit connection with a socket. The socket may be designed to establish an electrical and/or form-fit connection with a plug. Alternatively, the plug or the socket may be formed on a side of the component that faces away from the side of the component on which the cable may make electrical contact with the contact means. In addition, the course of the guide from the contact means to the contact conductors of the plug or socket is designed in such a way that the arrangement and/or assignment of the electrical conductors of the plug or socket differs from that of the contact means. For example, an electrical connection may be made from a small cable cross-section of a cable to a large plug assembly or socket assembly. Preferably, at least two contact conductors of the socket assembly or the plug assembly have a greater or smaller distance to each other than the electrical conductors of the cable have to each other in the cable cross-section.

The electrical conductors may preferably only and/or directly extend to and/or adjoin a or the contacting surface of the cable, preferably in order to enable piercing of the contact means, in particular in the form of contacting tips and/or piercing means, into the electrical conductors at the contacting surface, wherein the contact surface preferably extends transversely, in particular perpendicularly, to the direction in which the cable extends, and wherein in particular the contact surface may be a cut surface of the cable, at which the cable has preferably been shortened to a desired length, and/or a cable end of the cable. Preferably, the contact surface may be formed by a cut at any point along the extension of the cable, in particular if the coding extends over the entire length of the cable. Preferably, the contact means are designed in such a way that it is only possible to pierce the electrical conductors of the cable by means of the contact means, in particular without cutting.

According to a further possibility, it may be provided that the respective conductor forms a line with a surrounding insulating sheath. If several conductors are provided, the lines may be color-coded, in particular by a different color of the insulating sheaths. It may then be advantageous to use a corresponding counter-coding on the guide device in order to color-code a guide structure and preferably openings of the guide housing to the corresponding lines. This may have the advantage of facilitating the installation and maintenance of the lines, as the color coding allows the lines to be quickly identified.

It is also advantageous if the conductors of the cable are each designed as strands in order to form a receptacle for inserting the associated contact means of the component, preferably for piercing the contact means in the form of a contacting tip into the strands. The guide device may be provided between the cable and the component in order to guide the insertion and preferably piercing with a predetermined arrangement and assignment of the contact means of the component with the conductors of the cable.

Another object of the invention is a method for producing a connection of a cable to a component, comprising the following steps:
Providing a connection system with the cable and the component and a guide device, in particular according to the invention, wherein the component comprises at least one or multiple contact means each for contacting an associated conductor of the cable, wherein a conductor cross-section of the respective conductor is exposed and accessible from the outside,
Inserting the respective contact means through the exposed conductor cross-section of the associated conductor in order to establish contact between the contact means and the conductor, wherein the insertion is guided linearly by the guide device, and wherein the insertion is controlled by an insertion mechanism in such a way that the respective contact means is inserted into the associated conductor with a predetermined depth of penetration in an axial direction of the conductor and/or the cable.

The method according to the invention thus has the same advantages as those described in detail with reference to a guide device according to the invention and/or a connection system according to the invention.

Advantageously, the invention may provide that the respective conductor forms a line with a surrounding insulating sheath, wherein the cable is provided by cutting it to a desired length without stripping the respective line, and wherein the insertion of the respective contact means is performed without the prior stripping of the respective line.

The component is, for example, a plug connector or a device such as a sensor or actuator or a fieldbus module. For example, a plug connector of type M8 or M12 or RJ45 may be used. Furthermore, the plug connector may be designed as an essentially cylindrical (such as M8, M12) or rectangular (e.g. RJ45) plug connector. Furthermore, the plug connector may have a diameter, in particular a maximum diameter, in the range from 1 mm to 30 mm, preferably 2 mm to 20 mm, preferably 5 mm to 14 mm. Specifically, the diameter may be essentially 8 mm for M8 and essentially 12 mm for M12. In particular, the diameter may refer to the outer diameter of a thread of the plug connector, which is used for attachment to a device. The cable may in turn have an outer diameter in the range of 1 mm to 30 mm, preferably 2 mm to 20 mm, preferably 3 mm to 10 mm. In the case of M12 cables, for example, the diameters may vary in the range from 4 mm to 6 mm.

It is also possible for the cable to be designed as a power or data or hybrid cable. As a hybrid cable, the individual cable may be used for both energy and data transmission, for example. For example, one or more data lines and one or more power lines are provided for this purpose. The respective data and/or energy line may have an electrical conductor which is surrounded by a sheath, in particular an insulating sheath or shielding. The shielding may be made of an electrically conductive material, for example to shield against electromagnetic interference. Materials such as copper or aluminum may be used here. On the other hand, the insulating sheath may be made of an electrically insulating material. Materials such as ceramic, glass or plastic may be used here. The respective data line may be designed as an electrical or optical data line and preferably as a fieldbus and/or Ethernet line.

The component and in particular the plug connector may be used to establish a reliable and secure connection with the cable. This may make it possible to receive electrical current for power transmission and/or signals for data transmission and/or at least one other medium from the cable and/or transmit it on to a device. For this purpose, the component may have at least one or multiple contact means, each of which is electrically and/or mechanically contacted with an associated conductor of the cable. In other words, if there are several conductors of the cable, several contact means of the component may also be provided, and the contact means may be electrically and/or mechanically connected to the conductors. An associated contact means may thus be provided for each conductor of the cable to be contacted, which is connected to the associated conductor accordingly. It may be provided that only one contact means is connected (make contact) with exactly one associated conductor at a time until all contact means have been contacted with an associated conductor in order to complete the connection.

The respective contact means may be designed as an electrical contact means, i.e. electrically conductive, and the respective conductor may be designed as an electrical conductor. When connecting the cable to the component, the assignment of the contact means may be taken into account, i.e. the contact means are connected to the conductors of the cable provided for this purpose. The assignment thus defines which conductors belong to which contact means. In other words, it depends on the specific arrangement and/or assignment of contact means of the component with the conductors of the cable.

The cable may have at least one electrical conductor. It is preferred if at least two or three or four or more or a maximum of 10 electrical conductors of the cable are provided. Each of the electrical conductors may particularly preferably be designed as a strand. In particular, a strand is understood to be an electrical conductor that has thin single wires and is therefore easy to bend, which is made predominantly of copper, for example. The single wires may be enclosed by a common insulating sheath (insulation), in which case the conductor may also be referred to as a stranded wire.

Furthermore, at least one coding may be provided on the cable. The coding may be formed spatially, i.e. in particular three-dimensionally, on the cable. Furthermore, the coding may be provided on a contacting and, in particular, cut surface of the cable. The coding may be used to specify a specific arrangement and/or assignment of, in particular electrical, contact means of the component with the, in particular electrical, conductors of the cable, preferably to specify and/or guide the connection. A coding may preferably be understood as a systematic shaping and/or arrangement of contacts and/or mechanical elements in order to ensure a specific connection configuration. The coding may thus serve to avoid incorrect connections and to ensure the correct alignment of the component (e.g. in the form of a plug connector) with respect to the cable during the connection process. The coding thus advantageously defines a correct orientation of the component, i.e. the correct orientation of the cable, and enables optimized signal transmission and power supply by ensuring compatibility between the different components.

The connection between the component and the cable may be made directly at a contacting surface and in particular a cut surface of the cable. The contact surface may designate a surface and, in particular, a cross-section through the cable at which the respective conductor of the cable is accessible from the outside for contacting with the contact means of the component. The surface may be arranged orthogonally to the axial direction of the cable. The respective conductor of the cable may directly adjoin an outer area of the cable at the contact surface and thus be connected to the contact means of the component without cutting through the sheath and/or insulation of the cable. The respective conductor may also be separated at the contact surface in alignment with the contact surface.

The cable may be designed in such a way that the respective conductor of the cable is accessible for contacting with an associated contact means. In particular, this means that the respective conductor is accessible from the outside (i.e. outside the cable), in particular that it may be contacted electrically from the outside without further measures such as stripping. This is made possible in particular by the fact that the respective conductor (for contacting) has an exposed conductor cross-section.

The coding may be provided directly on the cable (and thus not or not only on the plug connector). In particular, the coding may be formed between and/or in the area and/or through the conductors and/or the insulation and/or in or on the cable sheath (e.g. inner and/or outer sheath) on the cable. Coding is already known in plug connectors, in particular by means of electrical coding, in which the contacts are arranged in such a way that only the correct electrical connection is possible. According to the invention, this coding may be transferred to the cable, i.e. alternatively or additionally provided on the cable, for example in the form of a mechanical and/or electrical coding. The coding may optionally also be referred to as a coding structure or connection structure.

While coding in the form of mechanical coding preferably involves a special shape of at least part of the cable or on the cable systematically, in the case of electrical coding the conductors of the cable may be arranged in such a way that only the correct electrical connection to the component is possible. Forming the coding on the cable may have the advantage that the connection process between cable and component is significantly simplified and accelerated. This is due to the fact that the component may be connected directly and immediately to the cable.

It is possible that the cable according to the invention has a coding and/or a connecting structure which runs in the axial direction (longitudinal direction) of the cable or the conductors of the cable. The connecting structure may have the coding and/or a plug-in structure and/or a (geometric) profile. Furthermore, the connecting structure, in particular the coding and/or the plug-in structure and/or the profile, may extend over substantially the entire or predominant length of the cable and/or be provided continuously and/or repeatedly. In other words, the connecting structure may have a structural section which is repeated in the axial direction of the cable.

The coding or the connecting structure, specifically the structural section and/or the plug-in structure, may comprise at least one or more or exactly one cavity. A part of the component, such as a respective guide pin, may be plugged into the cavity or one or each of the cavities. The coding may be provided by a special geometric shape (in particular polygon) of the (respective) cavity. Furthermore, the coding may also be defined by a number of corners and/or edges of this shape. It is also conceivable that the coding is provided by several of the cavities, e.g. based on the arrangement and/or size and/or possibly different shapes of the cavities.

In particular, the coding or connection structure makes it possible to significantly reduce the necessary assembly steps for a connection process between the cable and component. Furthermore, even after the cable has been cut to size, the cut cable as such may already have the necessary structure to enable direct connection of the component.

It is possible that the cut cable has a plug-in structure, in particular provided by the coding and/or connection structure. This has the advantage that the cable may be connected directly to the component after it has been cut to a desired length. This is made possible in particular by the fact that the plug-in structure is provided continuously or repeatedly in the axial direction along the cable. As such, and therefore immediately after cutting, the cut cable may already have the necessary structure on its cut surface to enable direct connection of the component.

It is also conceivable within the scope of the invention that a contact surface is provided on the cable, at which the respective conductor is accessible for contacting with the associated contact means. The contact surface may lie in the cutting plane of the cable. In other words, the contact surface may be located at the plane at which the cable was cut. At the contact surface or cutting plane, the conductor or conductors may adjoin or protrude outwards from an interior of the cable and be visible from outside the cable. Furthermore, the respective conductor preferably protrudes from the contact surface or is located in a recessed position in the cable. It is also conceivable that a respective exposed conductor cross-section is also located in the cutting plane. This provides an easy-to-connect structure that allows the cable to be inherently designed as a plug or socket.

It is also advantageous if the respective contact means is designed to be inserted, preferably pierced, on and/or through the exposed conductor cross-section of the associated conductor. In other words, in the case of several conductors, each of the contact means may be inserted into a conductor cross-section provided for this purpose. Furthermore, the respective conductor with its (respectively) exposed conductor cross-section and the (respectively) inserted, preferably pierced, contact means may be at least partially surrounded by an insulating sheath. It is therefore not necessary to strip the conductor—i.e. remove the insulating sheath—in order to make the connection. This simplifies and speeds up the installation of the cable.

The special design of the cable according to the invention has the advantage that, when connecting the cable to the component, it is not necessary to first strip the cable in a complex process and, for example, use crimp connectors to connect a plug connector to the cable. Instead, it may be possible to connect the component directly to the cut cable, as the cable already has a structure, preferably a plug-in structure and/or coding, on the cut surface for mechanical and/or electrical contacting. The conductors of the cable may also be designed in such a way that they already provide a favorable contact surface at the cut surface. This is made possible in particular by strands with a diameter that allows contact means to be plugged and/or pierced into the strands.

It is also advantageous if the at least one coding comprises a mechanical and/or geometric coding of the cable, in which a geometric profile, in particular a spatial shape and/or contour, extends in the axial direction of the cable, e.g. is arranged continuously or repeatedly. The profile may define at least one cavity and in particular guide cavity, preferably the spatial shape and/or contour of the cavity. The at least one cavity may be provided for a pin or the at least one guide cavity (for guiding) may be provided for a guide means such as a guide pin of the component, so that a specific orientation of the component (relative to the cable) is predetermined for the connection and/or the connection of the component to the cable is blocked in the event of a deviation from the specific orientation. The specific orientation may also be predetermined by the specific shape of the at least one cavity, e.g. by the shape of the wall and/or the opening formed by the wall. The opening may, for example, have a rectangular or trapezoidal shape that corresponds to the shape of the pin, in particular the guide pin. This ensures that the component or pin is inserted in exactly the right position and is not skewed or twisted. In other words, the opening of the cavity may be shaped such that the at least one contact means and/or the at least one pin of the component may only be inserted therein in the correct orientation of the component. Furthermore, the at least one cavity may have a length that corresponds to the length of the pin that is inserted into the respective cavity. It is also conceivable that a plurality of cavities form a grid on the contacting and/or cut surface of the cable, which are arranged in such a way that the at least one contact means and/or the at least one pin of the component may only be inserted there in the correct orientation of the component.

It is further possible that the or at least one further cavity and in particular a guide cavity is designed for the transmission of a fluid, preferably for the transmission of a medium such as air or a liquid. Accordingly, the cable may serve not only to transmit electrical energy, but optionally also to transmit the fluid, such as a medium such as air or liquid. In other words, the coding may also be used to transmit a medium that is different from electrical energy. This enables the cable to be used in a variety of ways. The cable may therefore be designed not only as an electrical cable, but alternatively or additionally also as an air and/or fluid cable.

According to a further possibility, it may be provided that the at least one coding comprises a geometric and/or extruded profile of the cable and/or a tube and/or a grommet. In particular, the mechanical and/or geometric coding may be provided by the cable having a specific geometric profile. The specific geometric profile may be provided, for example, by the shape of at least one cavity and/or an opening of a cavity of the cable.

Furthermore, boundaries such as walls of the cable may be provided, which form the opening and the cavity, for example. The boundaries may be arranged and shaped in such a way that the specific geometric profile is created. The boundaries are made of plastic, for example. The boundaries and/or the profile may advantageously be extruded directly on the cable, e.g. by forming the boundaries and in particular walls in the cable.

It is also possible for the mechanical and/or geometric coding and/or the profile to be subsequently attached to the cable, e.g. by means of a guide device and/or a grommet and/or a tube. The grommet may be attached to the cable from the outside. The tube may also be guided inside the cable, for example. This makes it easy to produce the coded cable. Furthermore, the coding may be arranged in the cable, in particular inside a cable sheath of the cable, and/or outside the cable sheath.

Furthermore, a shape of the coding may deviate from the (in particular original, geometric) basic shape of the cable, preferably cylindrical basic shape of the cable, such as a cylindrical structure provided by the cable sheath. In other words, the coding may be a structure specially provided on the cable, which is provided on the cable specifically for the purpose of enabling the specific arrangement and/or assignment as described above.

The cable may also optionally have a grommet. The grommet may have a specific profile, e.g. a specific square or round shape, which provides the coding. The grommet may further serve to insulate and mechanically protect the electrical conductors within the cable. The grommet may be made of a high temperature resistant material such as polyethylene or silicone and designed to provide optimum strain relief for the conductors contained within the cable. In addition, the grommet may be provided with a special coating that minimizes electrical conductivity and thus reduces the risk of short circuits. The grommet may further comprise one or more chambers that serve to separate the individual conductors from each other, thus improving electrical insulation and/or (through the shape and/or arrangement of the chambers) providing the coding.

It is also conceivable in the context of the invention that the at least one coding comprises, as an alternative to or in addition to the mechanical and/or geometric coding, an electrical coding of the cable, in which a systematic arrangement of the electrical conductors of the cable is provided, so that a specific assignment of the electrical contact means of the component is predetermined for the connection. This may be understood to mean that the conductors of the cable have a predetermined arrangement in which the conductors have different (in particular lateral) distances from each other in accordance with a coding specification. These differences must also be provided for in the contact means of the component, i.e. the component must have a corresponding counter-coding so that the connection is possible. This ensures that a correct electrical connection is made between the contacts.

It is also advantageous if the electrical conductors of the cable are each designed as a strand in order to form a receptacle for inserting at least one electrical contact means of the component, preferably for inserting and/or piercing the respective contact means in the form of a contacting tip, in particular in the axial direction of the cable and/or on a contact surface. The design as a strand has the advantage that the strand may have several single wires, which may provide better accommodation for the contact means due to their flexibility. In particular, the mechanical deformability of the single wires may therefore be utilized during the connection in order to insert the contact means into the strand and to obtain reliable contacting when inserting/piercing the contact means.

A mechanical force may be exerted on the cable or conductor in the axial direction of the cable (i.e. longitudinal direction of the cable) or conductor in order to connect and preferably insert the respective contact means, i.e. in particular for insertion and/or piercing. However, a leading contact means and/or a (possibly also leading) guide pin of the component may first be applied to the cut surface of the cable in order to then insert this contact means into an associated conductor or to insert this guide pin into at least one cavity of the cable. In this process, the other contact means of the component finally touch the conductors of the cable at the cut surface. The force may then be exerted in the longitudinal direction of the cable to insert/pierce the contact means into the conductors. This process may also be referred to as “piercing”, but unlike conventional solutions, this is not done on the side of the cable, but axially on the cut surface of the cable.

Furthermore, it may be provided that a recurring marking is provided which indicates the depth of penetration of the electrical contact means, preferably in the form of piercing means. The marking may, for example, be provided on the outside of a cable sheath, e.g. printed on. The marking may be repeated at fixed intervals in the longitudinal direction of the cable in order to obtain an indication of the depth at which the contact means have been correctly inserted, starting from the cut surface, after the cable has been cut. This makes the connection even simpler and more reliable. The marking may also help with the orientation of the cable for the connection.

The cable and/or component and/or connection system may be designed for Single Pair Ethernet (SPE). In contrast to conventional Ethernet, which usually has four wire pairs or conductor pairs per cable, SPE reduces the need for cables, resulting in compact and cost-effective connections. Such a cable preferably has only one pair of wires or only one pair of conductors. The cable may preferably comprise a twisting of the pair of wires or the pair of conductors. The single wire or conductor pair may be designed to transmit data as well as electrical current or voltage, preferably over distances of up to 1000 meters and/or at a maximum data transmission speed of 10 Mbps, 100 Mbps or 1 Gbps. Furthermore, the cable may be designed to supply an end device with electrical current or voltage in accordance with Power over Data Line (PoDL) and transmit data at the same time. Preferably, the cable and/or the component and/or the connection system may be used or be suitable for use in Industry 4.0, Internet of Things (IoT), the automotive industry or building automation applications. The conductor pair or the wire pair preferably comprises or consists of copper or a copper alloy. Preferably, the cable corresponds to a single pair Ethernet cable according to IEEE 802.3bw, preferably in the validity of this standard on 27.09.2024, in particular in the Federal Republic of Germany. Preferably, the cable may be designed for full-duplex communication.

The component may preferably be a Single Pair Ethernet plug connector (SPE plug connector), in particular in accordance with the IEC 63171 standard, preferably in accordance with the status as of 27.09.2024, in particular with effect for the Federal Republic of Germany. Particularly preferably, the component may be designed as a plug connector or circular plug connector with an M8 or M12 thread. The plug assembly or the socket assembly of such a plug connector may have a thread for attachment, in particular to an electrical device or sensor. Furthermore, the cable and/or the component and/or the connection system may be designed to transmit a maximum power of 50 or 60 watts.

It may be preferred for conductors to be the conductors of the cable, unless otherwise specified. In other words, they may preferably only be conductors of the plug assembly or socket assembly if it is explicitly stated that they are the conductors of the plug assembly or socket assembly.

Two interacting codings may be referred to as coding and counter-coding.

### BRIEF DESCRIPTION OF THE SEVERAL VIEWS OF THE DRAWINGS

Further advantages, features and details of the invention are apparent from the following description, in which embodiments of the invention are described in detail with reference to the drawings. The features mentioned in the claims and in the description may be essential to the invention individually or in any combination. The drawings showing:

FIG. 1 Variants of cables and components according to embodiments of the invention, each in a sectional view.

FIG. 2 Parts of components according to embodiments of the invention, each in a sectional view.

FIG. 3 Various conductors of cables according to embodiments of the invention, each in a perspective view.

FIG. 4 a perspective view of a contacting or cut surface of cables according to embodiments of the invention.

FIG. 5 a perspective view of a contacting side of components according to embodiments of the invention.

FIG. 6 a perspective view of a component according to embodiments of the invention.

FIG. 7 a perspective view of a component according to embodiments of the invention.

FIG. 8 a sectional view of a cable and a component connected thereto according to embodiments of the invention.

FIG. 9 a perspective view of a contacting or cut surface of a cable according to embodiments of the invention.

FIG. 10 a top view of a cable according to embodiments of the invention.

FIG. 11 a method according to embodiments of the invention.

FIG. 12 a perspective view of a guide device according to embodiments of the invention.

FIG. 13A perspective view of a cable according to embodiments of the invention.

FIG. 14A further perspective view of a cable according to embodiments of the invention.

FIG. 15A schematic representation of an insertion mechanism according to embodiments of the invention.

FIG. 16A further schematic representation of parts of an insertion mechanism according to embodiments of the invention.

FIG. 17 Another schematic representation of an embodiment of a connection system.

FIG. 18a Another schematic representation of an embodiment of a component.

FIG. 18b Another schematic representation of an embodiment of a component.

FIG. 19a Another schematic representation of an embodiment of a connection system with a seal.

FIG. 19b Another schematic representation of an embodiment of a connection system with a seal.

FIG. 19c Another schematic representation of an embodiment of a connection system with a seal.

### DESCRIPTION OF SPECIFIC EMBODIMENTS OF THE INVENTION

In the following figures, the identical reference symbols are used for the same technical features, even for different embodiments.

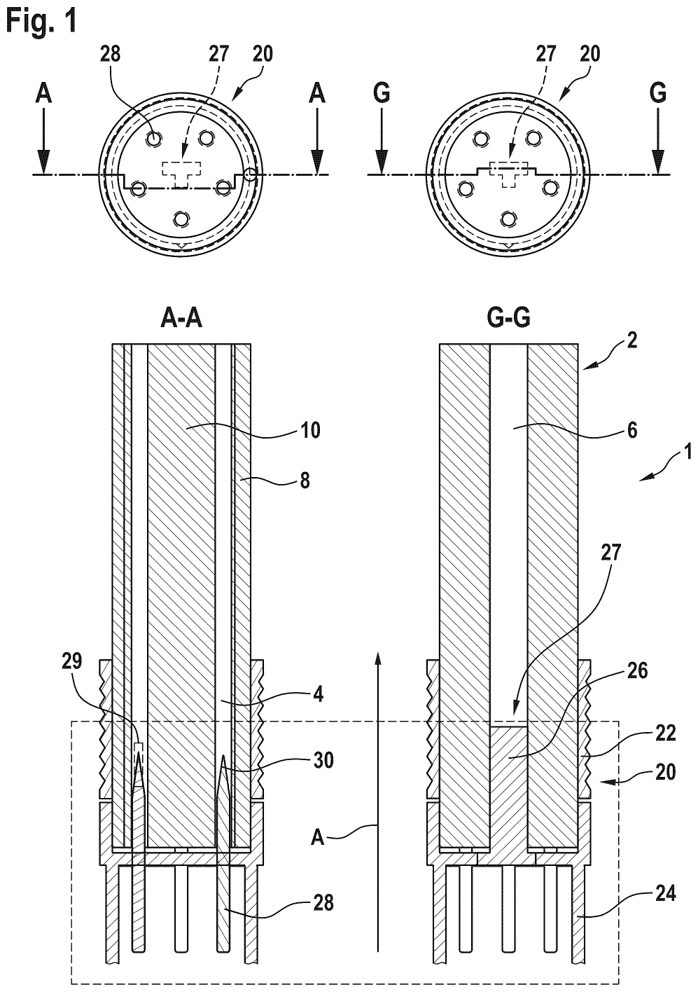

FIGS. 1 to 10 schematically illustrate embodiments of the invention. Specifically, variants of an electrical cable 2 are shown, which is used to connect to an electrical component 20. The cable 2 may have at least one electrical conductor 4 for this purpose. Furthermore, a connection system 1 according to embodiments of the invention is illustrated, which may comprise the cable 2 and the component 20. The sectional planes A-A and G-G are marked in the various views.

In FIG. 1, the cable 2 is shown in a state in which it is fully electrically and mechanically connected to the component 20. It may be seen that, in this state, the contact means 28 are inserted into the cable 20 and, in particular, into the electrical conductors 4 of the cable 20 in order to establish a secure mechanical and electrical contact. Clearly visible here, the contact means 28 have a tip 30 in order to be pierced into the conductors 4. The component 20 is designed here as a plug connector, possibly with a threaded screw connection arranged in the area 24, in order to be attached to a connection of a device such as a fieldbus module, actuator or sensor. This allows the cable 2 to be connected to the device for transmitting electrical energy and/or data via the plug connector.

In contrast to conventional solutions, the design of the cable 2 may significantly simplify the connection between component 20 and cable 2. For this purpose, structural additions may be made to the cable 2, such as, for example, at least one coding 50 formed spatially on the cable 2. In FIG. 1 it may be seen that the cable 2 has at least one cavity 6, which serves to form the at least one coding 50 on the cable 2 as further illustrated in FIG. 9 (see, for example, FIG. 9). Such a coding 50 may also be provided on the component 20 and then in particular be referred to as counter-coding 27 if this is formed complementary to the coding 50 on the cable 2. The coding of the cavity 6 means that a correspondingly counter-coded pin 26, preferably guide pin 26, may only be inserted into the cavity 6 as guide means 26 if the orientation of the component 20 relative to the cable 2 is correct (i.e. according to a lock-and-key principle). Otherwise, the insertion of the pin 26 into the cavity 6 may be prevented by other parts of the cable 2. This may then also block the establishment of the connection between cable 2 and component 20. The coding 50 on the cable 2 may thus specify a specific arrangement and assignment of electrical contact means 28 of the component 20 with the electrical conductors 4 of the cable 2.

The at least one coding 50 may comprise a mechanical and/or geometric coding 50 of the cable 2, in which a geometric profile 7 extends in the axial direction A of the cable 2. In FIG. 1 and FIG. 9, the profile 7 may be provided by a t-shaped opening of the cavity 6 on the cable 2 and a corresponding t-shaped counter-coding 27 may be provided on the component 20. The cavity 6 may also be designed to transmit a fluid, preferably a medium such as air or a liquid. In addition to a t-shaped coding, an L- or Y-coding or other forms are also conceivable.

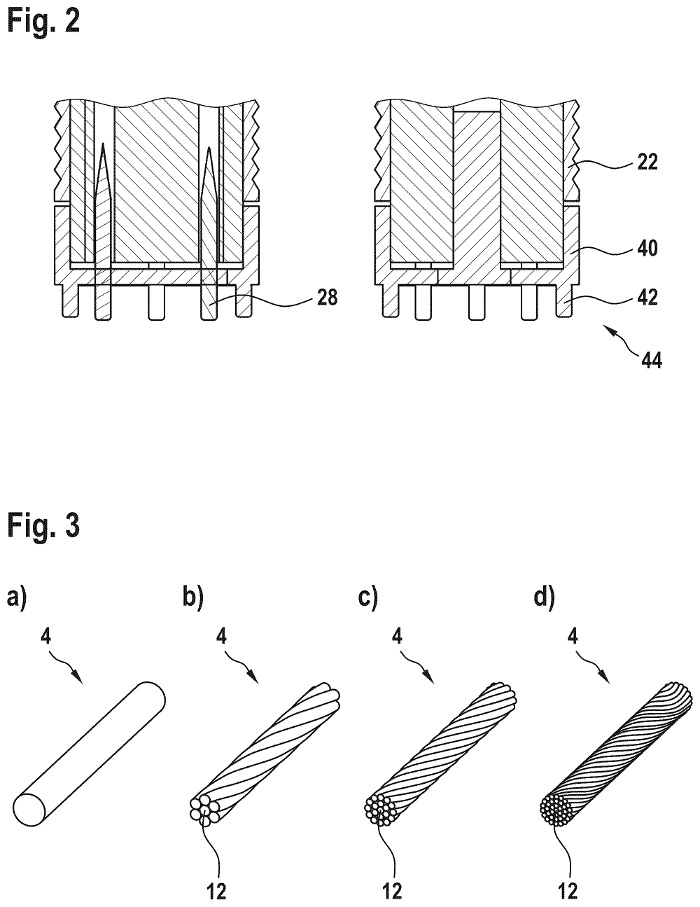

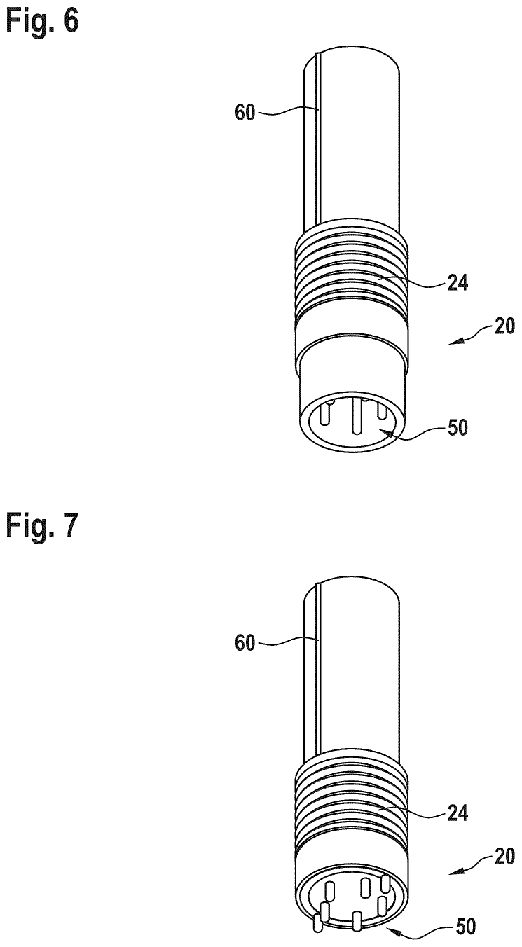

FIG. 2 shows an embodiment of the component 20 in the form of a plug connector, in which a protruding wall 40 is provided for connector assembly 40 (see also FIGS. 6 and 7). The wall 40 may, for example, be attached to a printed circuit board 42 of the component 20 in order to provide a locking device and/or anti-twist protection and/or a seal 44 on the cable 2. This wall 40 may optionally have a locking mechanism 22 to enable secure attachment to the cable 2.

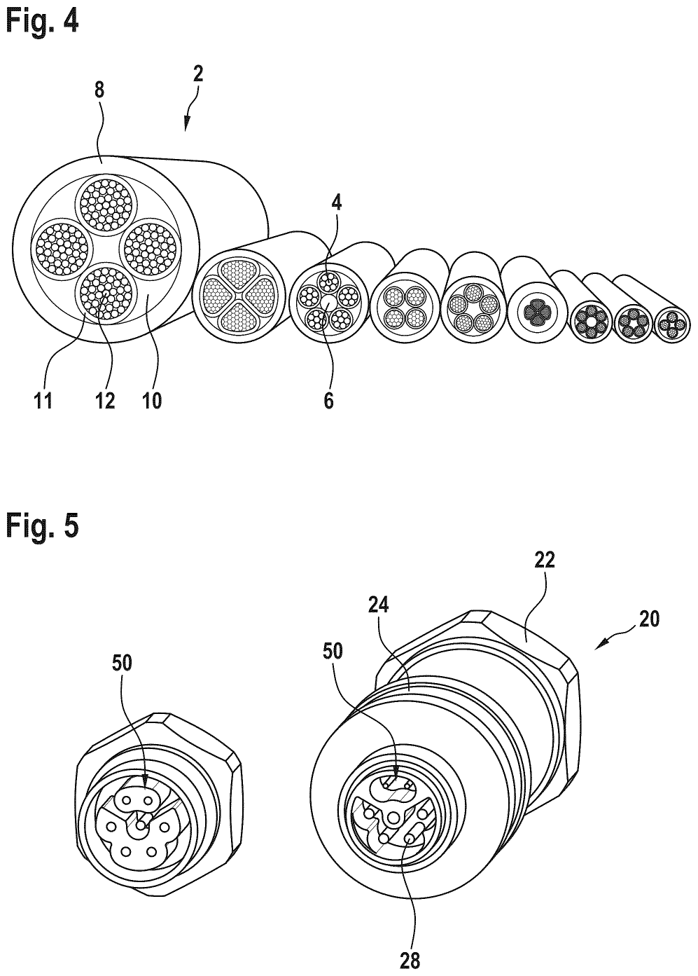

FIGS. 3 and 4 further illustrate that the cable may have the multiple conductors 4 in the form of strands, also referred to as stranded conductors. Each of these stranded conductors may have several fine, twisted wires 12, which may be surrounded by an insulating layer (insulation) recognizable in FIG. 4. This insulation is made, for example, from materials such as polyethylene or polyvinyl chloride. It may serve to insulate the conductors 4 both from each other and from the external environment. In addition, the insulation may often be color-coded to make it easier to identify and wire. In order to minimize electromagnetic interference, a shield made of a metal mesh or metal foil may be provided around the insulated conductors 4 as filling material 10. Furthermore, an additional inner sheath may be placed around the shielding to increase the mechanical stability of the cable 2. Furthermore, the entire cable 2 may have a robust outer sheath 8, which is preferably made of materials such as PVC, PE or thermoplastic elastomer and may have special properties such as flame resistance or oil resistance. This multi-layered structure allows the cable 2 to be highly flexible and robust, making it suitable for a wide range of applications.

In further optional designs of the cable 2, the conductors may be highly flexible and provided with 360° full shielding. This full shielding serves to effectively shield electromagnetic interference (EMC) and thus ensure the integrity of the data transmission. Other optional versions include overmoulded versions of the cable 2 with highly resistant PUR overmoulding, which are specially designed for use in harsh environments. The cables may be designed to be self-assembled, i.e. assembled in the field (on site at the system). In particular, this means that the cables themselves have the structural adaptations that allow them to be connected and disconnected quickly and easily and adapted to a desired length. In this way, the cables may be quickly adapted or replaced as required without the need for special tools or specialist knowledge.

The electrical conductor 4 may be made of copper or aluminum, for example. Other materials such as gold, silver, carbon fiber and conductive polymers may also be used as a component of the conductor 4, depending on the application. In addition, composite materials made from various of these elements may also be used in specialized applications in order to optimize specific properties such as conductivity, weight and corrosion resistance.

Further, the at least one coding 50 may comprise a geometric and/or extruded profile 7 of the cable 2 and/or a conduit (not explicitly shown) and/or a grommet. The at least one coding 50 may further comprise an electrical coding 50 of the cable 2, in which a systematic arrangement of the electrical conductors 4 of the cable 2 is provided, so that a specific assignment of the electrical contact means 28 of the component 20 is predetermined for the connection. In FIG. 5, a corresponding coding 50 is illustrated, in which the contact means 28 of the component 20 are arranged in a corresponding manner with different lateral spacings.

In FIGS. 1, 2 and 5-8, a component 20 for connection to an electrical cable 2 is shown schematically. The component may have at least one electrical contact means 28 for making electrical contact with at least one electrical conductor 4 of the cable 2 in an axial direction A of the cable 2 or conductor 4. The axial direction A, or longitudinal direction of the cable 2, is illustrated in FIG. 1 by a vertical arrow. Furthermore, the at least one electrical contact means 28 may be designed to make the electrical contact in the electrical cable 2—i.e. in particular within the sheath 8.

FIGS. 6 and 7 further illustrate that a further structure such as a locking and/or orientation structure 60 may be provided, for example, to further simplify the correct alignment of the component 20 relative to the cable 2 during the connection. The structure 60 is formed, for example, as a groove or material recess on the component 20 and/or on the cable 2.

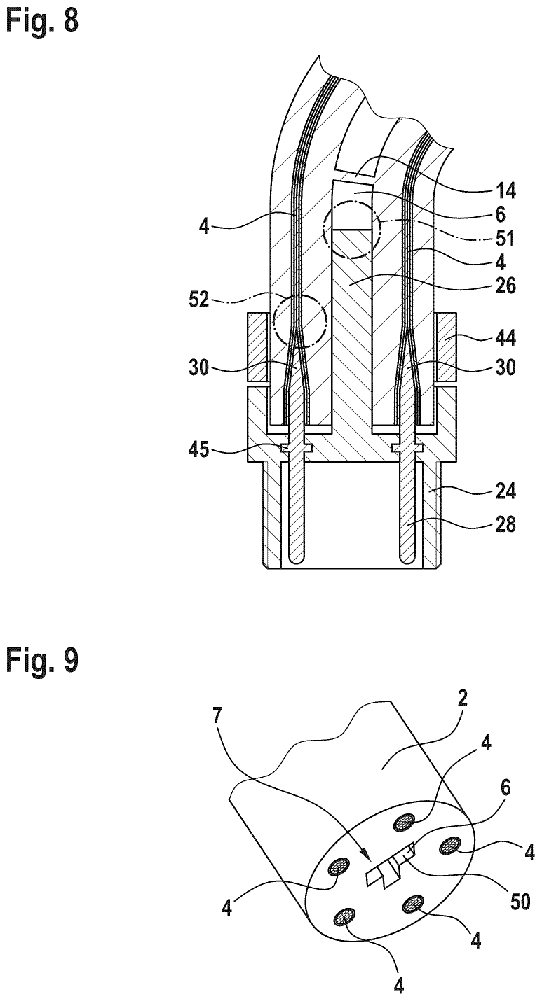

FIG. 8 shows that the cavity 6 of the cable 2 may also be interrupted by a connecting part 14. This connecting part 14 may repeatedly interrupt the cavity 6 in the axial direction A of the cable 2. In particular, it serves as a sealing for condensate. This has the advantage that moisture is prevented from penetrating the cable 2, thus ensuring that it remains functional. Accordingly, the connecting part 14 may also serve as a sealing element.

Furthermore, a locking pin 45 is shown in FIG. 8, which may be provided on the contact means 28 in order to fix the position on the cable 2 after the connection has been made. More generally formulated, a locking device 45 may be provided on the component 20 or on the cable 2 in order to fix the established connection.

It is further illustrated in FIGS. 8 and 9 that the coding 50 may comprise a first coding 51, which is provided by the shape of the cavity 6. This refers in particular to the shape of the opening of the cavity 6 with the profile 7 recognizable in FIG. 9. Alternatively or additionally, a second coding 52 may be provided, which is provided by the arrangement and/or formation of the conductors 4. In particular, the coding may be provided here by the formation of the strand 4 to the tip 30 of the contact means 28 or, conversely, the counter-coding may be provided by the formation of the tip 30 of the contact means 28 to the strand 4. Due to the tip 30, the contact means 28 may be designed accordingly as a needle, which then penetrates a conductor cross-section 5 of the conductor 4 for contacting during the connection (see FIG. 13). Different lengths of the contact means 28 may also be provided for a leading, e.g. of a safety contact means 29.

FIG. 8 further shows that the component 20 may comprise the at least one contact means 28 in the form of a piercing means, which is designed to be pierced into an electrical conductor 4 of the cable 2 in the form of an electrical strand 4 in the axial direction A of the cable 2 or the conductor 4. The bending apart of the single wires of the strand 4 at the pin tip 30 is illustrated in FIG. 8.

In FIG. 1 it is further illustrated by a dashed line that at least one of the contact means 28 may be designed as a safety contact means 29, which is designed to lead with regard to at least one or all of the other contact means 28. This allows the safety contact means 29 to contact one of the electrical conductors 4 of the cable 2 before the at least one or the other of the contact means 28 when the connection is made, i.e. during a contacting movement.

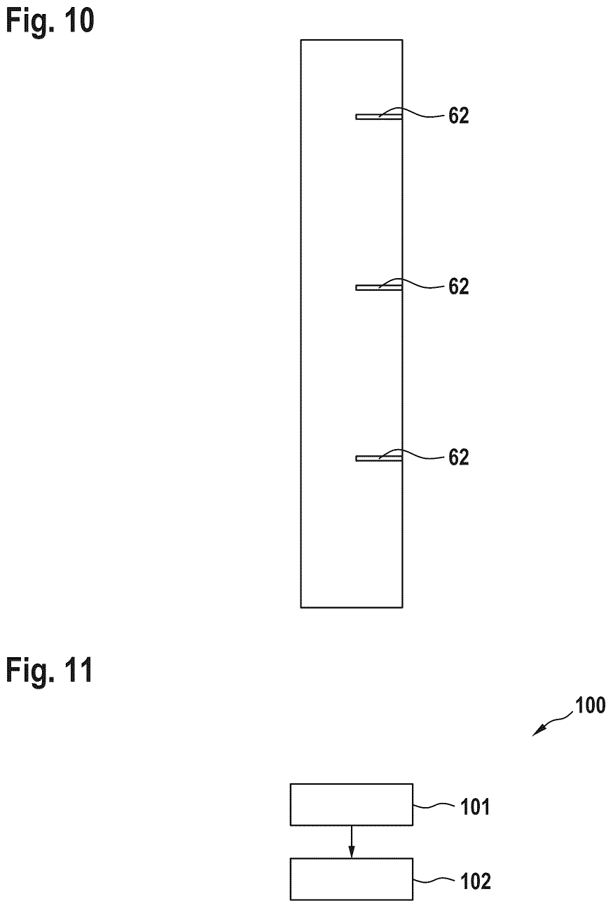

FIG. 10 shows that (e.g. every 5 mm) a recurring marking 62 may be provided on the cable 2, which indicates a depth of penetration of the electrical contact means 28, preferably in the form of piercing means. This marking 62 may be printed on, for example. The marking 62 may, for example, be provided in the form of a line or dot. The marking 62 may also be a mechanical marking which, for example, interacts with an insertion mechanism 80.

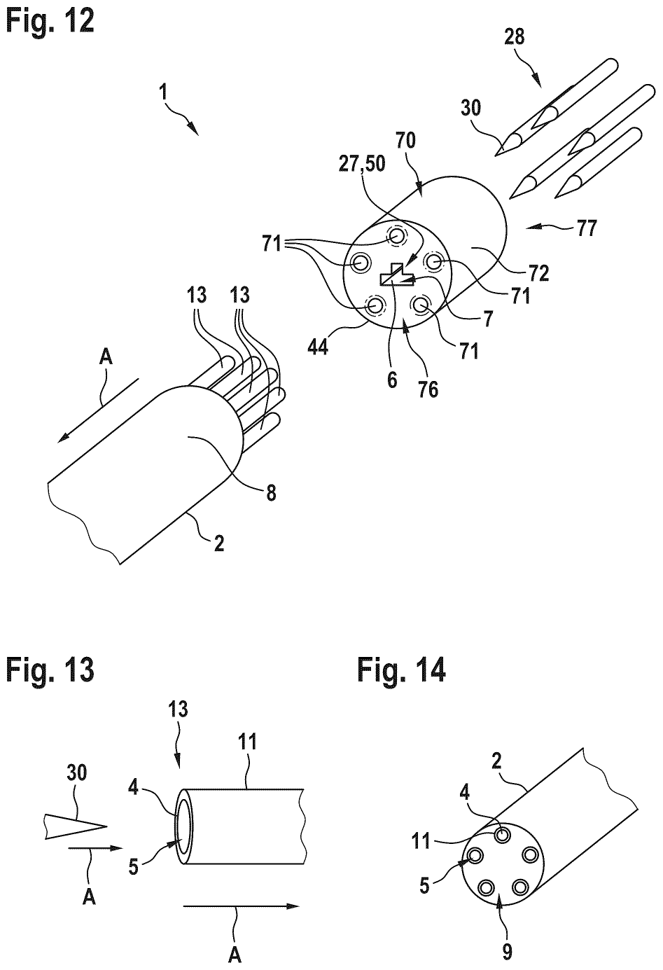

In FIG. 12, according to further embodiments of the invention, a connection system 1 with a component 20 and a cable 2 may be seen. The component 20 may be provided for connection to an electrical cable 2. For this purpose, the component 20 may comprise a plurality of contact means 28 for making contact with conductors 4 of the cable 2. In the electrical cable 2 shown, the conductors 4 may be accessible from the outside for contacting with the contact means 28. In FIG. 12, the conductors 4 are surrounded by an insulating sheath 11 and are thus part of lines 13, specifically stranded lines 13 (see FIG. 13). Both the contact means 28 and the conductors 4 are electrically conductive here. Furthermore, the conductors 4 may each have an exposed conductor cross-section 5 for contacting (see FIGS. 13 and 14).

The connection system 1 may be designed for contacting the contact means 28 with the conductors 4 in axial direction A of the cable 2 or conductor 4 in order to electrically connect the contact means 28 directly to the exposed conductor cross-sections 5. For this purpose, as illustrated in FIG. 13, the contact means 28 may each have a tip 30 and/or be needle-shaped. In other words, the conductors 4 may be contacted by piercing the contact means 28 through the exposed conductor cross-sections 5 in axial direction A.

In FIGS. 12 to 14, among others, a contact surface 9 is provided on the cable 2, at which the conductors 4 are accessible for contacting with the contact means 28. Specifically, the contact surface 9 may lie in a cut plane of the cable 2, which is created, for example, by cutting the cable 2 at this point. It may be seen that the conductors 4 there may be adjacent to the outside from an interior of the cable 2 (see FIGS. 13 and 14) or protrude (see FIG. 12) and are thus visible and accessible from outside the cable 2. In FIGS. 13 and 14, the respective exposed conductor cross-section 5 also lies in the sectional plane.

According to FIG. 13, the conductors 4 may each form a line 13 with a surrounding insulating sheath 11, whereby the lines 13 protrude from the contact surface 9 (see FIG. 12) or are flush with it (FIGS. 13 and 14). Furthermore, the solution according to embodiments of the invention may avoid stripping, so that the protruding conductors 4 and/or the exposed conductor cross-sections 5 are each still completely or partially surrounded by the insulating sheath 11. However, the protruding conductors 13 may be at least partially or completely freed from a cable sheath 8 of the cable 2 over the entire circumference (see FIG. 12).

The connection system 1 may have a guide device 70 shown in FIG. 12, which is formed separately from the cable 2 and the component 20 and/or is movably or detachably connected to the cable 2 and/or the component 20. The guide device 70 may be designed to mechanically guide the contacting in the axial direction A of the cable 2, and preferably to guide the conductors 4, in particular the lines 13, and/or the contact means 28 for contacting in the axial direction A of the cable 2. In other words, the guide device 70 may provide a linear guide for the cable 2 and/or the component 20. When the component 20 and the cable 2 move in a linearly guided manner relative to each other for contacting, this may also be referred to as a contacting movement.

The guide device 70 may have a guide housing 72 with a guide structure 71. In FIG. 12, the guide structure 71 is specifically provided in the form of openings of the guide housing 72 in order to provide the mechanical guide for the respective conductors 4, in particular cables 13, and/or contact means 28. As shown in FIG. 12, the guide structure 71 may be formed on a first side 76 of the guide housing 72 to receive the conductors 4, in particular cables 13, and may be formed on another, opposite second side 77 (facing away from the first side 76) of the guide housing 72 to receive the contact means 28.

The lines 13 in FIG. 12 may have different colors and thus be color-coded. Corresponding colors may also be provided in the area of the openings 71 to facilitate assignment.

Furthermore, at least one coding 50 or counter-coding 27 with the properties as described above may also be provided on the guide device 70, for example in the form of a guide grommet.

A part 44 of the component 20 and/or the guide device 70 in FIG. 12 may seal the contact surface 9 in the connected state and/or mechanically lock it and/or provide anti-twist protection. Here, for example, an O-ring or a sealing lip on the guide device 70 is conceivable as a sealing element. A latching lug (not explicitly shown) or a latching hook may serve as a locking element. A projection or a groove may serve as anti-twist protection.

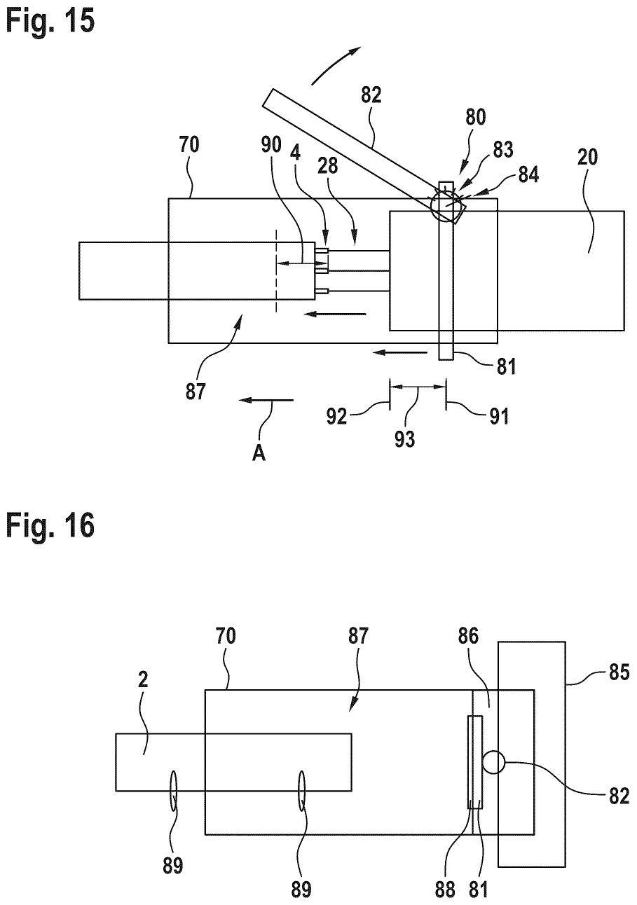

FIGS. 15 and 16 show an example of an insertion mechanism 80, which may be arranged on the guide structure 71 for controlling the contacting movement in order to insert the at least one or the multiple electrical contact means 28 into the associated electrical conductor 4 with a predetermined depth of penetration 90 in an axial direction A of the conductor 4 and/or the cable 2.

The insertion mechanism 80 may be designed to insert, in particular pierce, the respective contact means 28 linearly guided by the contacting movement into the associated electrical conductor 4 with the predetermined depth of penetration 90, in particular depth of piercing 90, the predetermined depth of penetration 90 preferably being in the range from 0.5 mm to 10 mm, preferably 1 mm to 6 mm, preferably 2 mm to 4 mm.

The insertion mechanism 80 may further comprise a pressure element 81 and a transmission arrangement 82. Here, the transmission arrangement 82 may be connected to the pressure element 81 in a force-transmitting manner in order to set the pressure element 81 in motion when force is applied manually or mechanically to the transmission arrangement 82. In this way, the respective electrical contact means 28 may be introduced, preferably pierced, into the associated electrical conductor 4 by the pressure element 81 via the contacting movement. Here, a travel 93 for the pressure element 81 between a starting position 91 and an end position 92 may be determined by the predetermined depth of penetration 90 and/or may be structurally predetermined. Furthermore, an adjusting mechanism 84 may be provided to adjust the predetermined depth of penetration 90 and preferably the travel 93 in the insertion mechanism 80, preferably depending on a cable type of the cable 2 and/or continuously and/or in several predefined stages.

Furthermore, FIG. 15 schematically illustrates that the insertion mechanism 80 may be configured as a lever mechanism 80 in which a transmission arrangement 82 comprises a lever arm 82. This may serve to transmit a manual or machine application of force to the transmission arrangement 82 into the controlled contacting movement, in which the control is such that the contacting movement is linearly guided and/or the depth of penetration 90 is predetermined and/or controlled and/or limited and/or the predetermined and/or a current depth of penetration 90 is indexed for a user.

Furthermore, an indexing device 83, also illustrated in FIG. 15, may be provided in order to visually or haptically or acoustically indicate a current depth of penetration 90 during the contacting movement.

FIG. 16 shows that the insertion mechanism 80 may also have a nut 85, preferably a union nut 85, which is designed to establish a mechanical connection between the component 20 and the cable 2 and to be screwed onto a thread 86 for this purpose. Furthermore, a transmission arrangement 82 may be provided, which is designed to transmit a movement, in particular a rotary movement, of the nut 85 on the thread 86 to a pressure element 81. Furthermore, the pressure element 81 may be arranged and guided in the region of a guide space 87 in order to move through the guide space 87 of the guide structure 71 by the transmitted movement along a longitudinal axis of the thread 86 in order to thereby exert a force for inserting the electrical contact means 28, wherein the guide space 87 is designed to receive a part of the component 20 and/or the at least one electrical contact means 28.

Furthermore, according to FIG. 16, a holding element 88 may be provided, which is firmly connected to the pressure element 81 in order to limit the contacting movement when the holding element 88 encounters a counter-holding element 89.

In FIG. 11, method 100 for making a connection of a cable 2 to a component 20 according to embodiments of the invention is schematically visualized. According to a first method step 101, a connection system 1 with the cable 2 and the component 20 and a guide device 70 is provided, wherein the component 20 comprises at least one or multiple contact means 28 each for contacting an associated conductor 4 of the cable 2. A conductor cross-section 5 of the respective conductor 4 may be exposed and accessible from the outside. Furthermore, according to a second method step 102, the respective contact means 28 is inserted through the exposed conductor cross-section 5 of the associated conductor 4 in order to establish contact between the contact means 28 and the conductor 4. The insertion may be guided linearly by the guide device 70. Furthermore, the insertion 102 may be controlled by an insertion mechanism 80 in such a way that the respective contact means 28 is inserted with a predetermined depth of penetration 90 into the associated conductor 4 in an axial direction A of the conductor 4 and/or the cable 2.

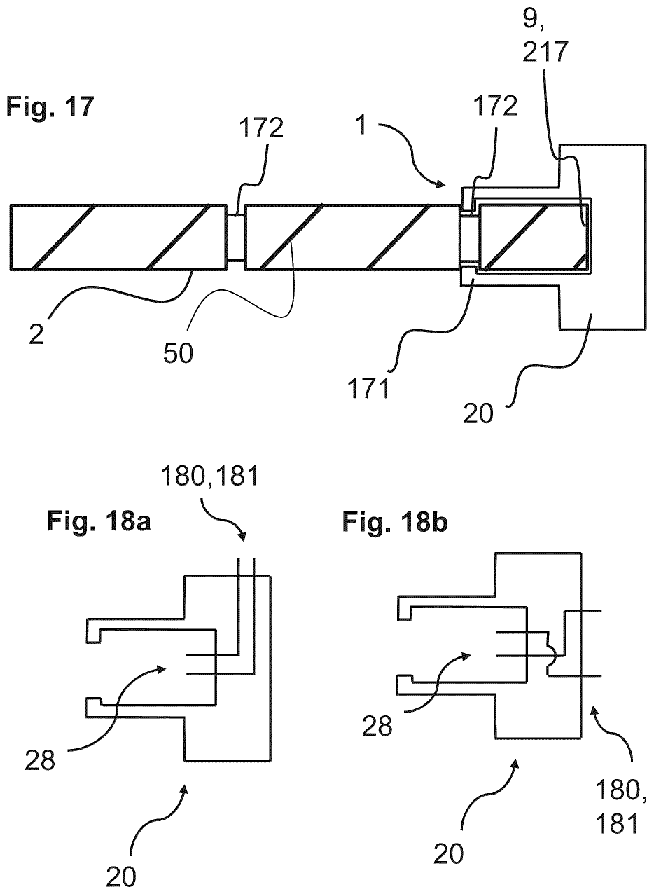

FIG. 17 schematically shows an embodiment of the connection system 1 according to the invention, which comprises an embodiment of the component 20 according to the invention and an embodiment of the cable 2 according to the invention. The cable 2 has a plurality of mutually spaced strain relief contours 172. The strain relief contours 172 are formed as circumferential grooves and are evenly spaced apart along the cable 2. A strain relief 171 of the component 20 engages in such a strain relief contour 172, wherein the strain relief 171 is formed in one piece with the component 20 and prevents that an accidental pulling on the cable 2 leads to an unintentional release of the electrical connection between the cable 2 and the component 20. The electrical connection is established by means of pointed contact means, each of which is pierced into only one predetermined electrical conductor of the cable. The electrical conductors of the cable 2 extend twisted to one another along the length of the cable 2. The cable 2 also has a coding 50 which interacts with a counter-coding of the component 20 in such a way that the contact means of the component 20 only come into electrical contact with the electrical conductors provided for this purpose during the establishment of the electrical connection between the component 20 and the cable 2, in that the coding 50 and the counter-coding together form a guide and prevent any other contact between the conductors of the contact means. For this purpose, the coding 50 of the cable 2 is formed on the circumference of the cable as a helical or threaded groove running in the direction of extension of the cable 2. Alternatively, instead of a groove, an analogously designed bead may be provided. The coding 50 has a continuous course along the direction of extension of the cable 2 and has the same relative position to the electrical conductors of the cable 2 at every point along the extension of the cable 2, transverse or perpendicular to the direction of extension of the cable 2. In other words, the cable 2 may be shortened to a desired length at any point of the cable 2 in order to establish an electrical connection between the cable 2 and the component 20, since the constant relative position along the cable ensures the intended electrical contacting. The contact surface 9 is formed at the cable end 217, at which the contact means are pierced into the conductors of the cable.

FIG. 18a shows a schematic embodiment of the component 20 according to the invention. The contact means 28 for contacting the electrical conductors of the cable may be seen. The contact means 28 lead electrically to contact conductors 180 of a plug 181 of the component 20, where the contact conductors 180 form a plug assembly 181. The course of the guide from the contact means 28 to the contact conductors 180 of the plug 181 is not formed in a straight line, but is angled at least once, preferably vertically, whereby the plug 181 is formed on a side of the component 20 that extends transversely or perpendicularly to the insertion direction of the cable 2. Instead of a plug 181 with a plug assembly 181, a socket with a socket assembly may be provided.

FIG. 18b shows a further schematic embodiment of the component 20 according to the invention, which differs from the embodiment of FIG. 18a in that the plug 181 is formed on a side of the component 20 that faces away from the side of the component 20 on which the cable may make electrical contact with the contact means 28. In addition, the course of the guide from the contact means 28 to the contact conductors 180 of the plug 181 is formed in such a way that the arrangement and/or assignment of the contact conductors 180 of the plug 181 differs from that of the contact means 28.

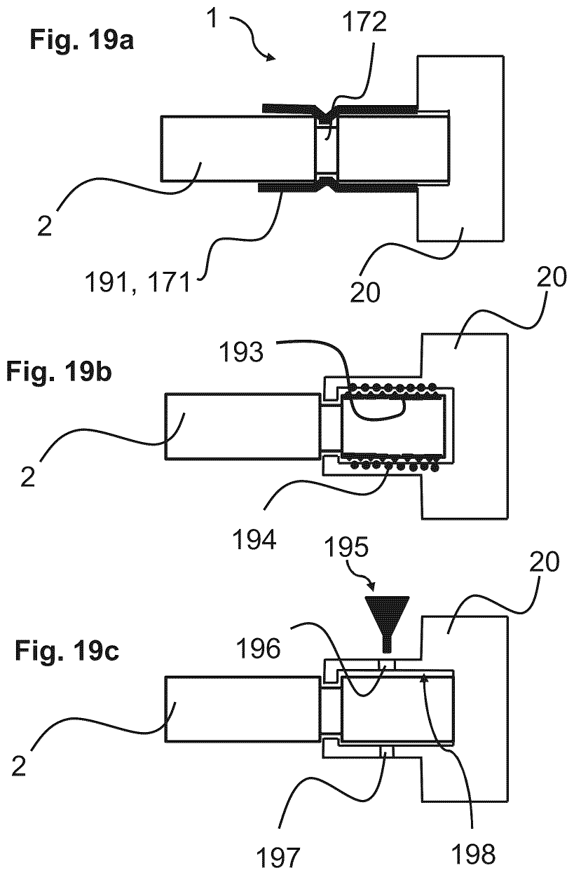

FIG. 19a shows an embodiment of a connection system 1. Here, a strain relief 171 is formed by means of a heat-shrink tubing 191. The heat-shrink tubing 191 also serves to seal the electrical connection between the cable 2 and the component 20. The heat-shrink tubing 191 engages in a circumferential groove that forms the strain relief contour 172. In addition, the heat-shrink tubing is attached to the component 20.

FIG. 19b shows a further embodiment of a connection system 1. Here, the cable 2 has a microencapsulation 193 which, on contact with an activation substance 194, releases a sealing compound which seals the electrical connection between the cable 2 and the component 20 to the environment. Of course, it is also possible that the component 20 has the microencapsulation while the cable 2 has the activation substance. Alternatively, it is also conceivable that the activation, i.e. the release of the microencapsulation, takes place by means of heat or light or radiation or in another suitable manner.

FIG. 19c shows a further embodiment of a connection system 1. Here, a sealing chamber 198 in the component, which is bounded by the cable 2 and the component 20, is sealed to the environment by means of a sealing compound 195. Preferably, the component 20 has a filler opening 196 for filling the sealing compound 195. Furthermore, the component 20 may have an outlet opening 197, from which the filled sealing compound 195 may escape if the sealed chamber 198 is already filled with the sealing compound 195. Alternatively or additionally, it is possible that the component 20 has a viewing window which delimits the sealing chamber 198, whereby a degree of filling of the sealing chamber 198 by means of the sealing compound 195 may be visually identified by a user.

The contact means are not shown in FIGS. 17 and 19a to 19c for ease of representation or are not visible due to the chosen representation.

The foregoing explanation of the embodiments describes the present invention solely by way of examples. Of course, individual features of the embodiments may be freely combined with one another, provided that this is technically expedient, without departing from the scope of the present invention.

### LIST OF REFERENCE SYMBOLS

1 System, connection system
2 cables
4 Core, strand, conductor
6 Cavity
7 Profile
8 Sheath, cable sheath
9 Contact surface, cut surface
10 Filling material
12 Single wire
14 Sealing for condensate
20 Component
22 Locking, unlocking
24 Threaded screw connection
26 Guide, guide means
27 Counter-coding
28 Contact means, pin
29 Safety contact means
30 Pin tip
40 Connector assembly
42 Printed circuit board
44 Locking device, anti-twist protection, seal
45 Locking pin
50 Coding
51 First coding
52 Second coding
60 Structure
62 Depth marker
70 Guide device
71 Guide structure
72 Guide housing
76 First side
77 Second side
80 Insertion mechanism
81 Pressure element
82 Transmission arrangement
83 Indexing device, indexing
84 Adjusting mechanism
85 Nut
86 Thread
87 Guiding space
88 Holding element
89 Counter-holding element
90 Depth of penetration
91 Starting position
92 End position
93 Travel
100 Method
101 First process step
102 Second process step
A Axial direction
217 Cable end
171 Strain relief
172 Strain relief contour
180 Contact conductor
181 Plug, plug assembly
19 Heat-shrink tubing
193 Microencapsulation
194 Activation substance
195 Sealing compound
196 Filler opening
197 Outlet opening
198 Sealed chamber

1. A guide device for assisting in making an electrical connection between a component and a cable, comprising:
a guide housing, and
a guide structure which is formed on the guide housing for guiding a contacting movement in order to contact at least one or multiple electrical contact means of the component with a respective associated electrical conductor of the cable,
characterized in that
the guide device further comprises:
an insertion mechanism, which is arranged on the guide structure for controlling the contacting movement, for inserting the at least one or the multiple electrical contact means in each case with a predetermined depth of penetration into the associated electrical conductor in an axial direction of the conductor and/or the cable.

2. The guide device according to claim 1,
characterized in that
the insertion mechanism is designed to insert, in particular pierce, the respective contact means linearly guided by the contacting movement into the associated electrical conductor with the predetermined depth of penetration), the predetermined depth of penetration preferably being in the range from 0.5 mm to 10 mm, preferably 1 mm to 6 mm, preferably 2 mm to 4 mm.

3. The guide device according to claim 1,
characterized in that
the insertion mechanism further comprises:
a pressure element and
a transmission arrangement,
the transmission arrangement being connected to the pressure element in a force-transmitting manner in order to set the pressure element in motion when force is exerted manually or mechanically on the transmission arrangement, in order to introduce, preferably pierce, the respective electrical contact means into the associated electrical conductor by means of the pressure element via the contacting movement, wherein a travel for the pressure element between a starting position and an end position is determined by the predetermined depth of penetration and/or is structurally predetermined.

4. The guide device according to claim 1,
characterized in that
an adjusting mechanism is provided to adjust the predetermined depth of penetration and preferably the travel at the insertion mechanism, preferably depending on a cable type of the cable and/or steplessly and/or in several predefined steps.

5. The guide device according to claim 1,
characterized in that
the insertion mechanism is designed as a lever mechanism, in which a transmission arrangement comprises a lever arm for transmitting a manual or mechanical force exerted on the transmission arrangement into the controlled contacting movement, in which the control is such that the contacting movement is guided linearly and/or the depth of penetration is predetermined and/or controlled and/or limited and/or the predetermined and/or a current depth of penetration is indexed for a user.

6. The guide device according to claim 1,
characterized in that
an indexing device is provided in order to visually or haptically or acoustically indicate a current depth of penetration during the contacting movement, the indexing device preferably being designed as one of the following for this purpose:
a visual scale for indicating the current depth of penetration, preferably by means of markings for different positions along a travel of a pressure element of the insertion mechanism,
a latching mechanism, in which latching means are provided at the various positions in order to give an operator of the guide device haptic feedback when the pressure element reaches the various positions,
a click or snap mechanism to provide acoustic feedback when the pressure element reaches the various positions,
a device with mechanical resistance elements at the various positions,
a device with magnetic position markers at the various positions.

7. The guide device according to claim 1,
characterized in that
the insertion mechanism further comprises:
a nut, preferably a union nut, which is designed to establish a mechanical connection between the component and the cable and is screwed onto a thread for this purpose,
a transmission arrangement which is designed to transmit a movement, in particular a rotary movement, of the nut on the thread to a pressure element,
the pressure element, which is arranged and guided in the region of a guide space, in order to move through the guide space of the guide structure by the transmitted movement along a longitudinal axis of the thread, in order thereby to exert a force for inserting the electrical contact means, the guide space being designed to accommodate a part of the component and/or the at least one electrical contact means.

8. The guide device according to claim 1,
characterized in that
the insertion mechanism further comprises:
a pressure element for directly or indirectly transmitting a force to the electrical contact means in order to introduce it into the associated electrical conductor via the contacting movement,
a holding element which is firmly connected to the pressure element in order to limit the contacting movement when the holding element encounters a counter-holding element,
wherein preferably the counter-holding element, and in particular also further counter-holding elements, are arranged at regular intervals along an axial direction of the cable for visual and mechanical identification of the predetermined depth of penetration on the cable.

9. The guide device according to claim 1,
characterized in that
the guide device is designed to predetermine the specific arrangement and assignment of the plurality of electrical contact means to the electrical conductors during contacting, the guide structure being designed to guide the contacting movement in the form of a linear relative movement of the electrical contact means and the electrical conductors with respect to one another during contacting.

10. The guide device according to claim 1,
characterized in that
the guide structure is formed on a first side of the guide housing for mechanically guiding the electrical conductors, and for this purpose preferably comprises openings on the guide housing, and is formed on a second side of the guide housing for mechanically guiding the plurality of electrical contact means, and for this purpose preferably comprises further openings on the guide housing in order to guide the electrical conductors and the electrical contact means towards one another starting from the different sides, so that the contacting is preferably provided guided in an interior space of the guide housing.

11. The guide device according to claim 1,
characterized in that
at least one coding is spatially formed on the guide housing in order to predetermine the specific arrangement and assignment of the multiple electrical contact means to the associated electrical conductors, the at least one coding comprising a mechanical and/or geometric coding, in which a geometric profile, in particular a spatial shape and/or contour, extends through the guide device, the profile preferably defining a guide cavity for a guide means and preferably for a guide pin of the component and/or the cable, so that a specific orientation of the component and/or of the cable is predetermined for the contacting, in order to block a movement of the component and/or of the cable relative to one another in the event of a deviation from the specific orientation, wherein the guide cavity is particularly preferably designed for transmitting a fluid, in particular for transmitting a medium such as air or a liquid, wherein the at least one coding comprises a geometric and/or extruded profile of the guide device and/or a tube.

12. The guide device according to claim 1,
characterized in that
at least one coding is provided on the guide housing, the at least one coding comprising an electrical coding and/or a color coding, in which a systematic arrangement of the electrical conductors is provided, so that a specific assignment of the electrical contact means is predetermined for the contacting.

13. The guide device according to claim 1,
characterized in that
the guide device comprises an insertion mechanism, in particular a screw mechanism, a lever mechanism or a plug-in mechanism, to perform the contacting movement, the insertion mechanism preferably being designed to move the cable in the direction of the component during the contacting movement, the guide device or the insertion mechanism preferably comprising an adjusting mechanism, for setting a predetermined depth of penetration of the contact means into the conductor at the insertion mechanism, preferably as a function of a cable type of the cable and/or continuously and/or in several predefined stages, wherein the guide device or the insertion mechanism preferably has an indexing means which is designed to index the current depth of penetration for a user during the contacting movement.

14. The guide device according to claim 1,
characterized in that
the guide device is designed as a guide grommet for the cable.

15. A connection system, comprising:
a component for connection to an electrical cable, wherein the component comprises at least one or multiple contact means for making contact in each case with an associated conductor of the cable, wherein the respective contact means is designed to be electrically conductive,
the electrical cable, in which the respective associated conductor is accessible for contacting, wherein the respective conductor is designed to be electrically conductive, and wherein the respective conductor has an exposed conductor cross-section,
a guide device for supporting the contacting of the respective contact means with the associated conductor, the guide device having a guide housing which is designed to be at least partially electrically insulating, and the guide device having a guide structure which is designed on the guide housing for guiding a contacting movement of the respective conductor and/or of the respective contact means for contacting,
characterized in that
the guide device further comprises:
an insertion mechanism, which is arranged on the guide structure for controlling the contacting movement, for inserting the respective contact means with a predetermined depth of penetration into the associated electrical conductor in an axial direction of the conductor and/or the cable.

16. The connection system according to claim 15,
characterized in that
the connection system is designed for contacting the respective contact means with the associated conductor in an axial direction of the associated conductor, in order to electrically connect the respective contact means directly to the exposed conductor cross-section of the associated conductor and/or in that the at least one coding is formed by means of a rotationally symmetry-free cross-section of the cable, in particular by means of a rotationally symmetry-free inner and/or outer contour of the cable.

17. The connection system according to claim 15,
characterized in that
the respective contact means each has a tip and/or is needle-shaped in order to contact the associated conductor by the contact means being pierced at and/or through the exposed conductor cross-section.

18. The connection system according to claim 15,
characterized in that
the respective conductor is designed as a strand which has flexible single wires in each case in order to electrically conductively surround a contact means which is introduced and in particular pierced through the respective conductor cross-section.

19. The connection system according to claim 15,
characterized in that
the respective contact means is designed to be introduced, preferably pierced, into the conductor at and/or through the exposed conductor cross-section of the associated conductor, the respective conductor with its exposed conductor cross-section and the contact means introduced, preferably pierced, therein being at least partially surrounded by an insulating sheath.

20. The connection system according to claim 15,
characterized in that
the electrical conductors of the cable are twisted together, in particular in the form of one or more twisted pairs, twisted threes or twisted fours,
that the at least one coding has a continuous course along the length of the cable and a course matched to the twisting such that at each point of the cable along the length of the cable the at least one coding and the electrical conductors have the same relative position to one another, in particular in a plane transverse, preferably perpendicular, to the direction in which the cable extends.

21. The connection system according to claim 15,
characterized in that
the cable has a fluid line, in particular a liquid line or gas line,
that in particular the at least one coding is formed partially or only by means of the fluid line,
that the electrical conductors, in particular the stranding or strandings, surround the fluid line along the extension of the cable, preferably in order to ensure uniform cooling of the conductors by means of the fluid which may be conducted through the fluid line,
in that the component has a fluid channel which is connected in a fluid-transmitting manner to the fluid line of the cable and in particular in part or only forms a counter-coding.

22. The connection system according to claim 15,
characterized in that
the cable has along its extension on its outer circumference, preferably at regular intervals from one another, strain relief contours, particularly preferably in the form of circumferential recesses, in particular grooves or notches, or elevations, in particular beads or steps, preferably for a heat-shrink tubing or a strain relief, and in that the component has a strain relief, in particular a heat-shrink tubing which is formed as a strain relief and is preferably attached to the component, for the cable, which heat-shrink tubing interacts with the strain relief contour of the cable in such a way, that the cable is strain-relieved by the strain relief forming a form-fit, in particular with the strain relief contour of the cable, preferably by the strain relief engaging behind the strain relief contour or engaging in the strain relief contour.

23. The connection system according to claim 15,
characterized in that
an electrical connection is established between the cable and the component, in particular in that the contact means are pierced into associated conductors, and/or in that the connection system comprises a seal, in particular a material-fitting and/or force-fitting and/or form-fitting seal, which seals the connection and in particular a cable section adjacent to the connection from an environment of the connection system, in particular in accordance with IP20 or IP67, in that the seal is preferably formed, in particular in the case of a form-fit seal, by means of a heat-shrink tubing or the heat-shrink tubing which forms the strain relief.

24. The connection system according to claim 15,
characterized in that
the seal is formed by means of a sealing compound, in particular adhesive or casting compound,
in that, in particular in the direction of extension of the cable and/or perpendicular to the direction of extension of the cable, a sealing chamber for receiving the sealing compound is formed between the cable, in particular the contact surface of the cable, and the component, in which the sealing compound is located and preferably completely fills the sealing chamber, the sealing chamber preferably having a filler opening for the sealing compound, which is in particular closed by the sealing compound,
in that the sealed chamber preferably has an outlet opening for the sealing compound, which is closed in particular by the sealing compound,
in that, in particular, a section of the component delimiting the sealed chamber is formed from a transparent material so that the degree of filling of the sealed chamber with the sealing compound may be determined optically.

25. The connection system according to claim 15,
characterized in that
the seal is formed by means of a released content of the microencapsulation, in particular of the cable or the component or the guide housing.

26. The connection system according to claim 15,
characterized in that
the seal seals and/or electrically insulates a transition from the fluid line to the fluid channel in a fluid-tight manner with respect to the contact points, which are formed by means of contactings of the conductors with the contact means on the contact surface, and/or wherein the seal electrically insulates and/or seals the contact points, which are formed by means of contactings of the conductors with the contact means on the contact surface, with respect to one another.

27. The connection system according to claim 15,
characterized in that
the seal is formed by means of a heat-shrink tubing, in that the heat-shrink tubing is preferably formed as a strain relief of the cable, in that the heat-shrink tubing forms a form-fit in particular with a strain relief contour of the cable, preferably in that the heat-shrink tubing engages behind the strain relief contour or engages in the strain relief contour, and is attached to the component by means of an attachment of the component, in particular attachment contour of the component, and thus preferably forms a pretension of the cable against the component.

28. The connection system according to claim 15,
characterized in that
the contact means lead electrically to electrical contact conductors of a plug assembly or socket assembly of the component, in that the position and/or arrangement and/or assignment and/or dimensioning of the electrical contact conductors differs from that of the contact means, in particular on the contact surface.

29. The connection system according to claim 15,
characterized in that
the electrical conductors only and/or directly extend and/or adjoin a or the contact surface of the cable, preferably in order to enable piercing of the contact means, in particular in the form of contacting tips and/or piercing means, into the electrical conductors at the contact surface,
in that the contact surface preferably extends transversely, in particular perpendicularly, to the direction in which the cable extends,
and in that, in particular, the contact surface forms a cut surface of the cable, at which the cable has preferably been shortened to a desired length, and/or a cable end of the cable.
